(19) United States
(12) Patent Application Publication
(10) Pub. No.: US 2008/0053363 A1
(43) Pub. Date: Mar. 6, 2008

(54) Gravity and trip pin operated door open indication device

(76) Inventor: Silvano R Minella, Tucson, AZ (US)

Correspondence Address: Silvano R. Minella, 1971 N. Frances Blvd., Tucson, AZ, 85712, US

(21) Appl. No.: 11/545,433

(22) Filed: Oct. 10, 2006

Related U.S. Application Data
(60) Provisional application No. 60/841,499, filed on Sep. 1, 2006.

(51) Int. Cl. B60Q 1/50

(52) U.S. Cl. 116/28 R

(57) ABSTRACT

In accordance with present invention, the rear roll up trailer or cargo box door indicator is a gravity (and trip pin) operated device that mounts on the back of a trailer or cargo box with a roll up door, and a trip pin mounts to the center of one of the roll up door panels, approximately ⅛″ from the outside door frame. When the door is rolled up, the trip pin automatically releases the indicator out so that the driver can see the indicator device from the rear view mirror. When the door is closing, the trip pin catches the cam on the indicator and folds it back into its original position, out of sight of the drivers view, against the back (left) side of the trailer or cargo box, indicating that the door is closed.

### FIELD OF THE INVENTION

This invention relates to the field of trucking and delivery service industry, and more specifically, to any trailer or cargo box with a roll up door. This invention provides a cost effective measure of safety for all drivers, hostlers, and delivery personnel. This invention mounts on the back of the driver's side (rear outer frame) of the trailer or cargo box and the trip pin mounts to a panel on the roll up door, approximately 6.5′-7′ from the trailer or cargo box floor, and approximately ⅛″ from the outside frame.

This Application applies to the non-provisional application filed, USPTO 60/841499.

### BACKGROUND OF INVENTION

There is a need for a cost effective, maintenance free, easy to install indicator that allows the driver to know that the roll up door is closed.

There are a number of accidents that occur after the driver or hostler has closed the door and someone on the dock reopens the door without the driver or hostler's knowledge, and thinking that their door is shut, they begin to pull away from the dock. There could be a forklift re-entering the back of the trailer/cargo box, or a person entering or exiting the trailer/cargo box at the same time the driver or hostler is pulling away.

There are noted instances where forklifts have been driven onto trailers when the driver/hostler is pulling away from the dock, causing injury and/or death, as well as freight and equipment damage. Forklifts can fall from the back of the trailer/cargo box, or someone can be walking into or exiting the back of the trailer or cargo box if they enter the back after the driver has secured the door and walked away. If the door is opened 1″ or more, the indicator will automatically drop and will be visible from the driver's rear view mirror, letting the driver or hostler know not to pull away from the dock, and to exit the truck and close the door.

All of these scenarios cost the drivers, hostlers, and the company money, and can possibly risk a life or cost the loss of freight, damage to equipment, and other accidents. During the course of the day doing deliveries, drivers may be distracted and not sure if they shut the door before pulling away, and this indicator will allow the driver the ability to look in their rear view mirror and know that the door is either open or shut, reducing stress and distraction from the driver or hostler. Reassurance just takes a glance.

U.S. Pat. No. 7,095,322 shows a door open indication device using magnets. The current device, patent being applied for, uses a trip pin mounted to a door panel and a flag mechanism mounted to the outside of the trailer/cargo box (driver's side) that will drop and allow the driver to see that the door is open.

There are only 4 holes to be drilled to install this invention, it will be made of non-corrosive materials, and is maintenance free. This invention does not harm or lessen the integrity of the trailer/cargo box frame or roll up door. The flag stays securely in place when the door is down, by way of a trip pin that catches the flag, and when the door is opened even one inch, the trip pin moves and allows the flag to drop to the side of the trailer/cargo box, visible from the drivers rear view mirror. This invention is visible both day and night.

### SUMMARY OF THE INVENTION

In accordance with the present invention, there is a great need for a device to allow drivers and hostlers to be aware of their roll up door being open. The door indicator is composed of a trip pin mounted to the door panel itself and a indicator mechanism that mounts on the back side (left) of the trailer or cargo box. When the door is opened, even as much as one inch, the trip pin allows the flag indicator to drop, viewable from the driver's rear view mirror, visible both day and night. When the door is closed, the trip pin catches the flag indicator and pushes it back into an upright position, keeping it against the back of the trailer/cargo box. The device requires no batteries, electrical connections or magnets. The assembly is easy and only involves 4 small holes so there is no harm done to either the trailer/cargo box frame or the door itself. All parts need no upkeep and are rust and wear resistant.

### SUMMARY OF DRAWINGS

A description of the invention, corresponding to the drawings, is as follows:

FIG. 1 shows the rear of a trailer/cargo box and the trip pin and flag in its travelling position with the door closed.

FIG. 2 shows the trip pin having released the flag when the door is opened.

FIG. 3 shows the bracket that the trip pin is mounted with (on a door panel of the trailer/cargo box).

FIG. 4 shows the replaceable wear tip for the trip pin. The trip pin is constructed so that it swivels.

FIG. 5 shows the outer door frame of the trailer/cargo box frame.

FIG. 6 shows the flag on the mounting plate against the trailer/cargo box frame, in its upright position when door is closed.

FIG. 7 shows the flag mounting plate.

FIG. 8 shows the trip pin holding the flag up (against trailer/cargo box frame) when the door is closed. The trip pin is mounted on the roll up door panel.

FIG. 9 shows the different swivel positions of the flag (drawn as if you could see through the mounting plate). The mounts on the bracket (for the flag) also act as a stop for the flag in the up and down positions. The bottom of the flag cam is designed in such a way that it allows the trip pin to push it out when the door is opened and hold it securely in place when the door is closed. Flag will drop by way of gravity on its own, once the trip pin has passed the cam.

FIG. 10 is the flat mounting plate.

FIG. 11 is looking down on the mounting plate (with the tabs bent so they mount to side of trailer/cargo box).

FIG. 12 is a side view of the mounting plate for the flag (that mounts on the trailer/cargo box).

FIG. 13 is a screw, followed by

FIG. 14 washer as they both mount to

FIG. 15 the mounting plate for the flag.

FIG. 16 is a view of spacers placed on both sides of the flag.

FIG. 17 is a side view of the flag.

FIG. 18 is a threaded, flanged swivel pin that holds all of the parts of the flag together and onto the mounting plate.

FIG. 19 is the view the driver will have from his/her rear view mirror when the door is opened (even 1.0″) and the flag has dropped for the indicated door-open alert.

### DESCRIPTION OF PREFERRED EMBODIMENT

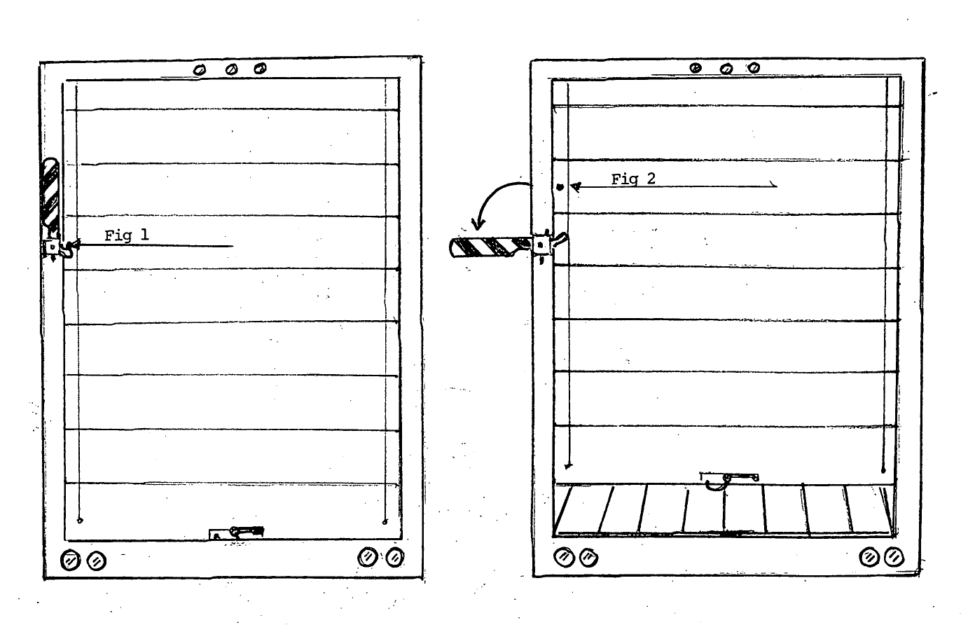

FIGS. 1 and 2 show the back of the trailer/cargo box and how the flag will ride when the door is closed (FIG. 1) and how it will drop and look when the door is opened (FIG. 2).

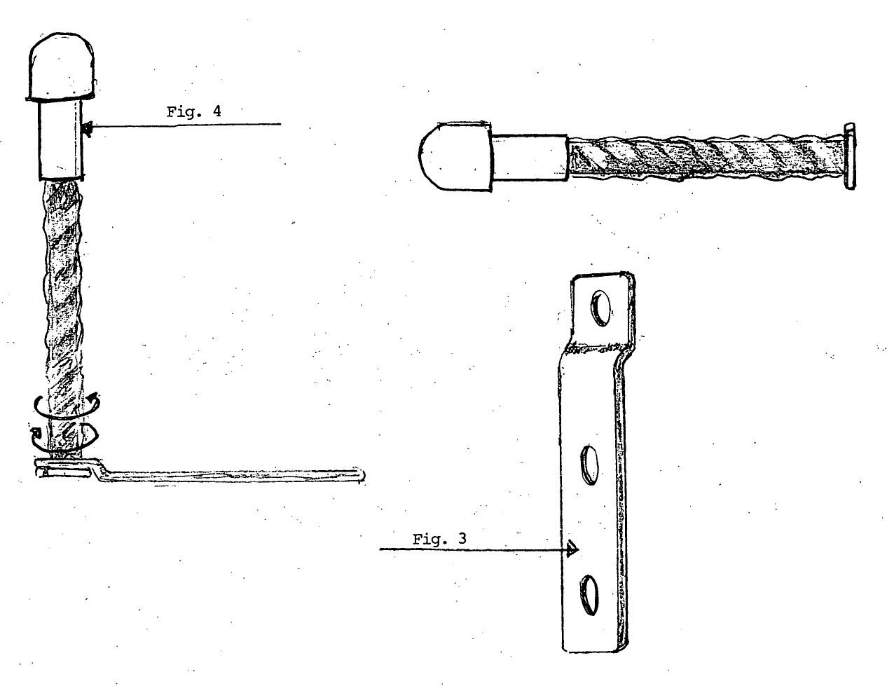

FIGS. 3 and 4 show the trip pin that mounts to the panel of the roll up door. The trip pin will swivel so it wears evenly if contact is made with the roof of the trailer/cargo box while going up and down. The trip pin also has a replaceable wear tip so that no damage is done if it rubs the top of the trailer/cargo box.

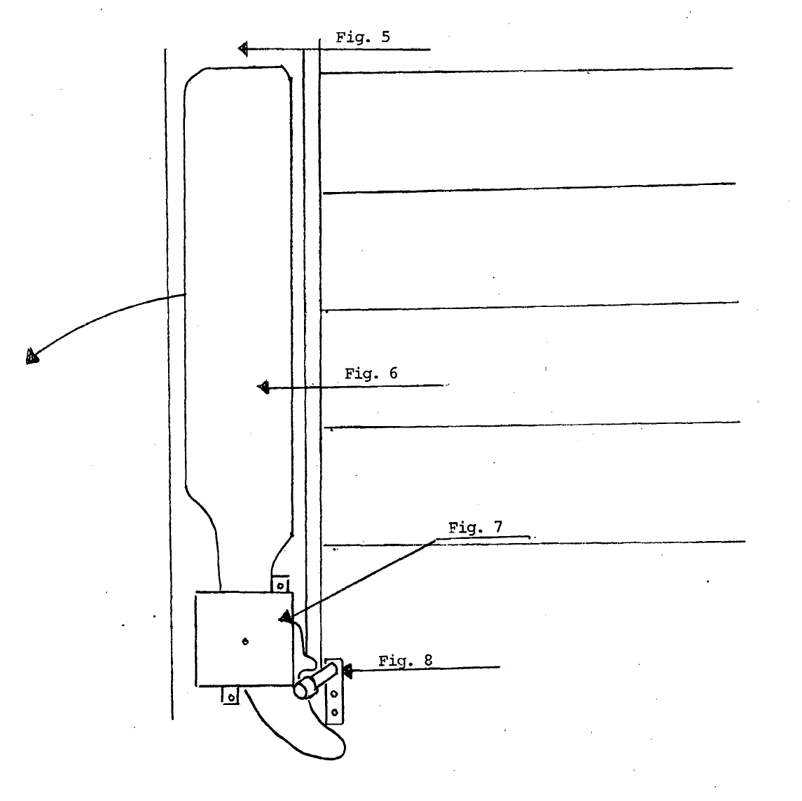

FIGS. 5-8 show the indicator flag and its mounted position on the back (driver's side) of the trailer/cargo box (FIG. 5-7), as well as the way the trip pin holds the flag in the upright position during transit (FIG. 8).

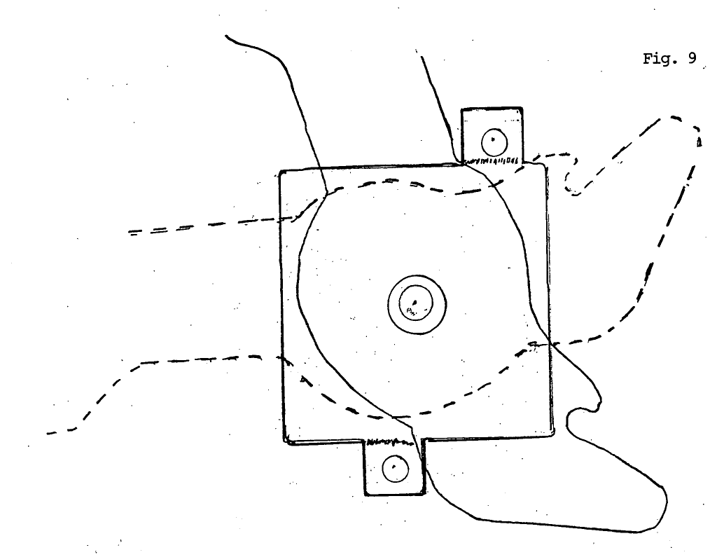

FIG. 9 shows the cam of the indicator flag and the two positions it can have and the where the tabs catch the flag when the trip pin passes it (when door is opened or closed).

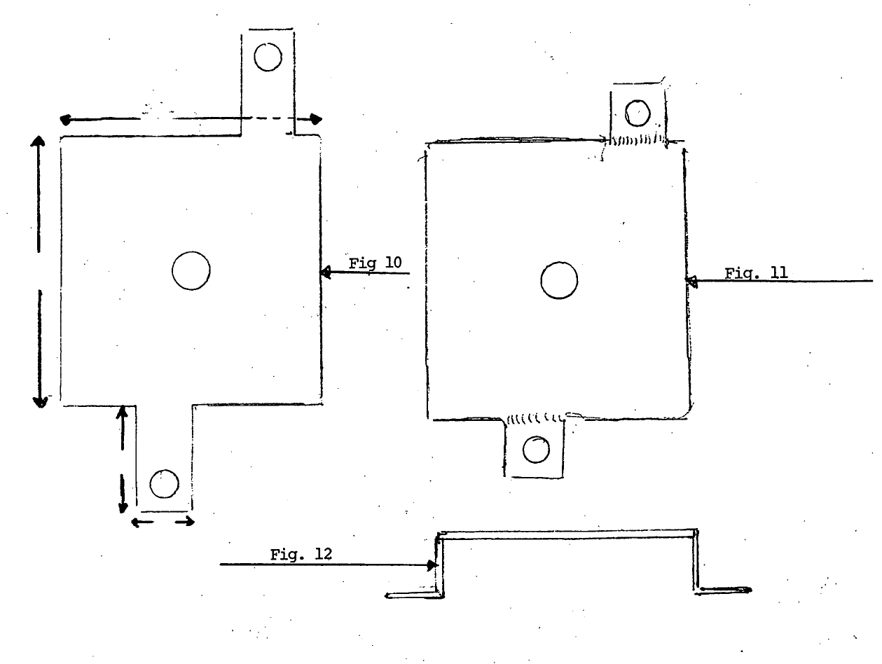

FIGS. 10-12 show the configuration of the flag cam plate (FIG. 10), and what it will look like when mounted to the back of the trailer/cargo box frame (FIG. 11 looking down on it) and a side view (FIG. 12).

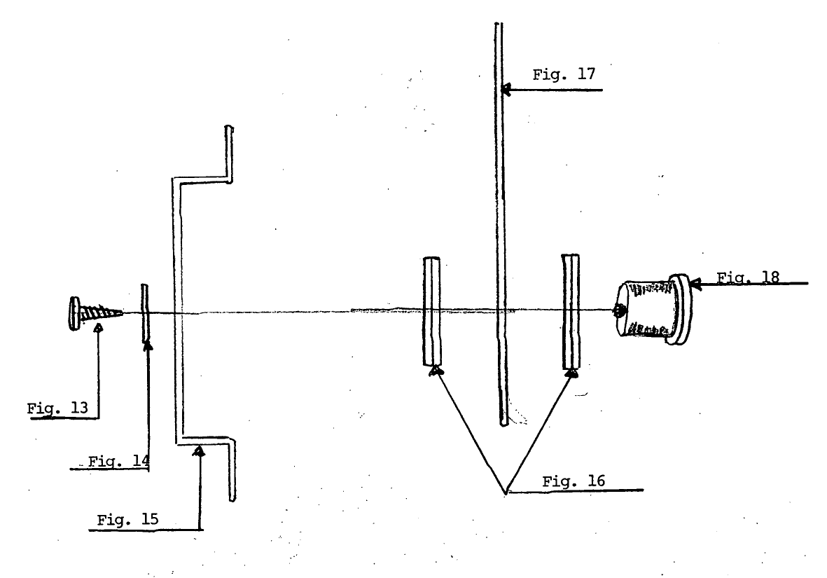

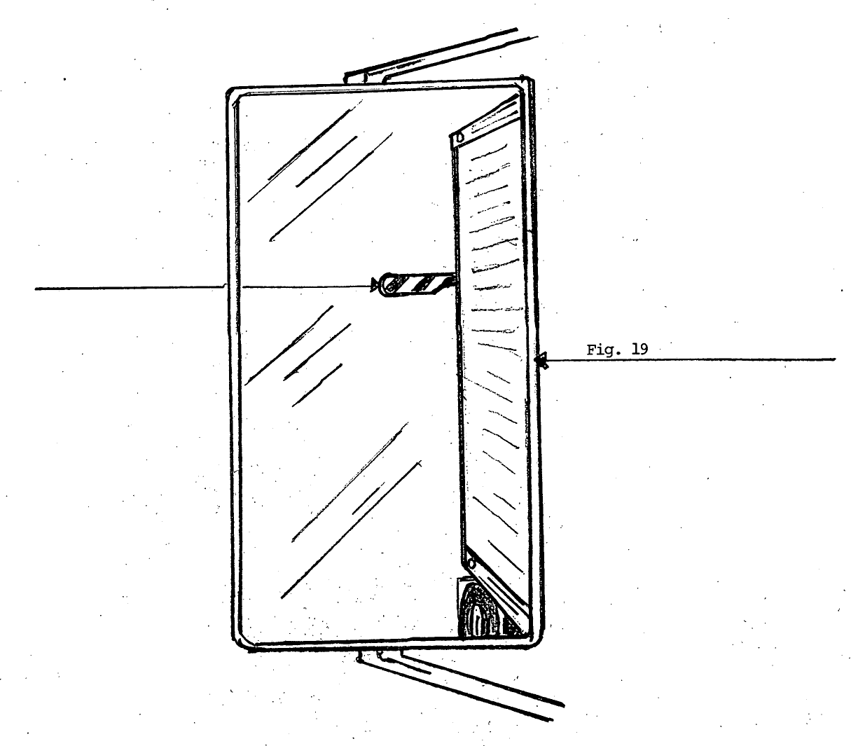

FIGS. 13-18 show an exploded version of the assembly of the flag and cam when it is put together and to be mounted to the back of the trailer/cargo box. Note that when the unit is sandwiched together, it does not come into contact with the rear door frame, allowing it to swivel freely.

What is claimed is as follows:

1. There is a great need for indication of the trailer/cargo box door being opened before pulling away from a dock or while out on deliveries.

2. The trip pin door-open indicator, in accordance with claim 1, this invention will save drivers time, and allow them to know that their door is shut without getting out to look at the back of their truck.

3. The trip pin door-open indicator, in accordance with claim 1, is a means of indicating a trailer/cargo box roll down door is open by way of a trip pin releasing/pushing a highly visible flag on the back side of the trailer/cargo box that will drop to the side of the trailer/cargo box and allow the driver to see that the door is open from the driver's rear view mirror.

4. The trip pin door-open indicator, in accordance with claim 1, has two separate parts; the trip pin mounts to the center of the door panel of a roll up door frame, approximately ⅛″ from the outside frame and the flag cam mounts to the back side of trailer or cargo box (drivers side).

5. The trip pin door-open indicator, in accordance with claim 1, when the door is opened, the trip pin on the door panel allows the indicator flag (by way of gravity) to drop on left side of trailer/cargo box, visible from the driver's rear view mirror, indicating door is open.

6. The trip pin door-open indicator, in accordance with claim 1, when roll up the door is shut, the trip pin strikes the indicator flag and allows the indicator flag back into an upright position against the back (left) side of trailer or cargo box, and at this point, the indicator is no longer visible from the driver's rear view mirror.

7. The trip pin door-open indicator, in accordance with claim 1, when the door is closed, the indicator is tucked against the back outside frame of the trailer/cargo box, so there are no protruding parts and it will not catch on obstacles, debris or wind when door is completely closed.

8. The trip pin door-open indicator, in accordance with claim 1, wherein the trip pin holds the indicator in place while in transit.

9. The trip pin door-open indicator, in accordance with claim 1, the trip pin is designed in such a way that when the door is rolled up, the trip pin flexes against the roof of the trailer/cargo box and does not catch on anything on the way up or down, immediately resuming its shape and retaining its rigidity once the trailer/cargo box door is closed, and will not cause any damage to the roof of the trailer/cargo box.

10. The trip pin door-open indicator, in accordance with claim 1, is a device that is low maintenance, needing no electrical wiring, battery connections or magnets to operate and the trip pin itself is designed for lack of wear on both the trailer/cargo box and itself.

11. The trip pin door-open indicator, in accordance with claim 1, is reflective from drivers rear view mirror, both day and night.

12. The trip pin door-open indicator, in accordance with claim 1, in best mode contemplated, the device is made of any material(s) that do not rust, are flexible, and need no upkeep.

13. The trip pin door-open indicator, in accordance with claim 1, the principle of the flag, cam

14. The trip pin door-open indicator, in accordance with claim 1, once mounted, the device will only require 4 small drill holes and will not affect the integrity of the surface it is mounted on.
